(19) United States
(12) Patent Application Publication
(10) Pub. No.: US 2006/0155604 A1
(43) Pub. Date: Jul. 13, 2006

(54) System and method for providing online user-assisted creation of magazine and web-based feature articles and advertising, with integrated online user-guided instruction for related marketing and sales activity

(76) Inventor: Rick Bard, New York, NY (US)

Correspondence Address: FROMMER LAWRENCE & HAUG, 745 FIFTH AVENUE- 10TH FL., NEW YORK, NY, 10151, US

(21) Appl. No.: 11/391,639

(22) Filed: Mar. 28, 2006

(51) Int. Cl. G06Q 30/00; G06F 17/21; G06F 17/24

(52) U.S. Cl. 705/14; 715/500; 715/505; 715/517

(57) ABSTRACT

A system and method for collecting advertisement and editorial information from an advertiser and/or an editorial source for use by a publisher to create an advertisement and/or editorial article and for providing related marketing information to the advertiser. For advertisers who wish to submit their own completed advertisement, a digital advertisement specification, which specifies the publisher's requirements for advertisements, is displayed to the advertiser. For advertisers who wish the publisher to create an advertisement for them, an advertisement creation worksheet is displayed, which prompts the advertiser to enter advertisement information. In addition, a set of editorial questions is displayed to the editorial source, which prompts the editorial source to enter editorial information. A digital communication, including advertisement information and editorial information, is received from the advertiser and the editorial source. A set of related marketing information is displayed to the advertiser, instructing the advertiser how to most effectively submit the advertisement and editorial information and how to most successfully use the advertisement and/or editorial article (which were created from the advertisement and editorial information) in an integrated portfolio of marketing tools.

### BACKGROUND OF THE INVENTION

1. Field of the Invention

This invention relates to electronically collecting advertising and editorial information for the creation of an advertisement and editorial story. More specifically, the present invention is a system and method for providing online, user-assisted creation of magazine and web-based feature articles and advertising tailored to the user, with integrated, online user-guided instruction for related marketing and sales activity.

2. Description of the Related Art

Under normal circumstances, publishers collect information from advertisers and editorial sources in sporadic, haphazard ways, using standard communication technologies, such as mail, telephone, facsimile, and email. The problem with doing so is that information is often lost or mis-communicated, resulting in poor advertisements, inaccurate editorials, and missed revenue resulting from inappropriate advertisements and improper follow-up.

U.S. Pat. No. 6,167,382 to Sparks et al. describes an integrated advertising-piece design and production system that allows a user to place a comprehensive order for images and templates used for the design, assembly, production, and distribution of print advertising and/or commercial display materials. The system creates an assembled image of the final product on the computer screen using pre-designed formats and images stored on a server.

U.S. Pat. No. 6,366,918 to Guttman et al. describes a computer-implemented method for optimizing the publication layouts of advertisements and stories using a special-purpose algorithm. U.S. Published Application 2005/0171837 to Eglinton describes a system for printing advertising from Internet web pages through the use of unique identifiers to associate printed advertisements with web pages. U.S. Published Application 2005/0259951 to Sugahara describes a system for recording a television broadcast on a recording medium (such as a DVD), along with printing an advertisement on a top surface of the recording medium.

U.S. Published Application 2005/0267803 to Patel et al. describes a computer-implemented method for correlating advertising campaigns with consumer interest, response, and sales. U.S. Pat. No. 6,931,591 to Brown et al. is related to a publishing layout wizard that facilitates the specification and distribution of templated content materials by a content provider over an information exchange network. U.S. Pat. No. 6,839,681 to Hotz describes a system for the evaluation and measurement of the performance of public relations, advertising, and sales events to a particular user in order to provide value-added relevance to marketing information. And finally, U.S. Published Application 2005/0267820 to Zheng is concerned with a computer-implemented method for finding customer-oriented ads by obtaining information about one or more items of interest to a buyer, and then selecting a seller to present to the buyer based on the obtained information.

However, none of the cited related-art patents or published applications disclose or suggest collecting advertising information, editorial information, and/or website information from an advertiser and/or an editorial source. None of the related art disclose or suggest communicating related marketing events and practices to the advertiser and/or the editorial source to assist the advertiser in getting the most out of the created advertising piece, website feature, and/or editorial.

### SUMMARY OF THE INVENTION

In view of the foregoing problems in the related art, an object of the present invention is to provide online user-assisted creation of print and online feature articles and advertising, with integrated online user-guided instruction for related marketing and sales activity. A separate article, advertisement, and/or online presentation is created from specific user inputs and includes information provided by the user. Through related online user-guided instruction, the user is prompted to evaluate marketing and sales policies to best provide the information requested.

The article and advertisement are published in print media, and the online presentation is placed on one or more web pages. Through related online user-guided instruction, the user is prompted to appropriately modify and adapt various marketing and sales policies into specific practices that best utilize the article, advertisement, and online presentation featured.

According to the foregoing, the present invention is achieved through the following methods and systems. One aspect of the invention is a method for collecting information from an advertiser and an editorial source. The method includes the steps of displaying to the advertiser an advertisement creation worksheet which requests advertisement information which the publisher will use to create an advertisement or a digital advertisement specification which specifies the publisher's requirements for submitted advertisements; receiving a digital communication from the advertiser and the editorial source which includes advertisement information and editorial information; and displaying to the advertiser a set of related marketing information on how to most effectively submit the requested advertisement and editorial information and how to most successfully use the created advertisement (which was created from the advertisement information and the editorial information in the digital communication).

Another aspect of the invention is a system for collecting information from an advertiser and an editorial source for use in creating an advertisement. The system includes a display for displaying to an advertiser and an editorial source an advertisement creation worksheet, a digital advertisement specification, and a set of related marketing information. The system receives a digital communication from the advertiser and the editorial source which contains advertisement information and editorial information.

In practice, the method is usually implemented using an information processing device, an information display device, and a communication link. In both the method and the system, there are generally two types of users—a publisher who receives information and one or more advertisers and/or editorial sources which submit information to the publisher. The information processing device is generally a computer configured in a server configuration running on the publisher's premises. The information display device is generally a computer configured in a client configuration running on an advertiser's or editorial source's premises. The communication link connects the information processing device to the information display device, via a public network such as the Internet or the PSTN (Public Switched Telephone Network).

According to one embodiment of the invention, the digital communication is in a form suitable for publishing in print and/or online.

In another embodiment of the invention, information about networking events is sent to the advertiser. The networking events can include, but are not limited to, receptions where advertisers, customers, and the publisher can interact and exchange business and contact information. In one embodiment of the invention, the publisher communicates the importance of such networking events to the advertiser, and how to use the networking events in an integrated portfolio of marketing tools (in conjunction with the printed and online advertisement).

In one embodiment of the invention, the publisher also collects information necessary to make an online version of the advertisement for publication on the publisher's website.

In yet another embodiment of the invention, the publisher receives payment information from the advertiser via the Internet, and processes the payment information to result in a payment from the advertiser to the publisher for the services rendered.

In yet a further embodiment of the invention, the publisher displays deadline information to the advertiser indicating various important deadlines for submitting the digital communication (which includes the advertiser information and the editorial information) to the publisher.

A further aspect of the invention includes displaying schedule information to the advertiser indicating projected dates of publication of the print medium (e.g., a magazine) and/or projected dates of online publication on the publisher's website.

It must be understood that the invention may be practiced over the Internet, or a similar public network (such as the Public Switched Telephone Network utilizing a modem). In the preferred embodiment, all communication between the publisher and the advertisers and editorial sources occurs over the Internet. In the case where communication takes place over the Internet's World Wide Web (WWW), the information display device used to display various information as required by this invention could use a web browser, but is not limited to such.

As one of ordinary skill in the art would readily appreciate, the same features described above with regard to the method can be equally applied to the system, and vice versa.

### BRIEF DESCRIPTION OF THE DRAWINGS

The above and other objects, features, and advantages of the present invention will be apparent from the following detailed description of illustrative embodiments which is to be read in connection with the accompanying drawings, in which:

FIG. 1 is a block diagram of a computer system to which the present invention is applied;

FIG. 2 is a schematic illustration of the present invention;

FIG. 3 is illustrative of the publisher displaying an advertisement specification to the advertiser;

FIG. 4 illustrates an example of advertisement information collected by the publisher utilizing an advertisement creation worksheet displayed to the advertiser;

FIG. 5 illustrates an example of editorial information collected by the publisher by displaying a set of editorial questions to the editorial source;

FIG. 6 illustrates some of the related marketing information displayed to the advertiser;

FIG. 7 illustrates some of the networking events and publication schedule information displayed to the advertiser; and

FIG. 8 illustrates an example of website information collected from the advertiser for use by the publisher in creating an online advertisement.

### DETAILED DESCRIPTION OF THE PREFERRED EMBODIMENTS

### First Embodiment of the Invention

The present invention is a method for creating an advertisement which uses an information processing device, an information display device, and a communication link for use by a publisher. According to the first embodiment of the invention, the publisher collects information from an advertiser and an editorial source. An advertiser is anyone who wants to advertise goods or services via a publisher. An editorial source is anyone, whether the advertiser himself, a customer of the advertiser, or an outside rating company, who provides editorial information to the publisher. The invention is not limited to collecting information from the advertiser and the editorial source. The publisher can collect information from just the advertiser or just the editorial source. In addition, both the advertiser and the editorial source may be the same person or organization.

For advertisers who wish to submit their own completed advertisement, a digital advertisement specification, which specifies the publisher's requirements for advertisements, is displayed to the advertiser. For advertisers who wish the publisher to create an advertisement for them, an advertisement creation worksheet is displayed, which prompts the advertiser to enter advertisement information. In addition, a set of editorial questions is displayed to the editorial source (which may or may not be the same as the advertiser), which prompts the editorial source to enter editorial information. Next, the publisher receives and collects a digital communication from the advertiser and the editorial source which includes advertisement information and editorial information, which could be in a form suitable for publishing in print and/or online, or which the publisher could use to create an advertisement and/or editorial article. The digital communication containing the advertisement and editorial information may be collected from the advertiser, who also acts as an editorial source by providing editorial information. Or, a first digital file containing advertisement information may be collected from an advertiser and a second digital file containing editorial information may be collected from an editorial source, such as a customer of the advertiser. Next, the publisher creates and edits the advertisement and/or the editorial article based on the advertisement information and/or editorial information collected. Thereafter, the publisher sends the advertisement and/or editorial article to the advertiser and/or editorial source for his review. Then, the publisher revises the advertisement and/or editorial article based on the advertiser's and/or editorial source's review. Finally, the advertisement and/or editorial article is published in print and/or online.

In conjunction with this process and in accordance with the inventive concept, the publisher displays to the advertiser a set of related marketing information to be considered in preparing and submitting the advertisement information and the editorial information as well as subsequent to publication to most successfully utilize the advertisement (which was created from the advertisement information and the editorial information) in an integrated portfolio of marketing tools. The marketing concepts and guidelines presented thus serve to guide the advertiser and/or editorial source while submitting advertisement and editorial information.

According to another inventive concept of the present invention, the publisher sends information about networking events to the advertiser. The networking events can include, but are not limited to, receptions where advertisers, customers, and the publisher can interact and exchange business and contact information. According to an inventive concept of the invention, the publisher communicates the importance of such networking events to the advertiser, and how to use the networking events in an integrated portfolio of marketing tools (in conjunction with the printed and online advertisement).

The present invention also includes a system for creating an advertisement and/or an editorial for use by a publisher during the course of publishing a magazine. The system includes an information processing device, an information display device, and a communication link. The communication link is used for communicating between the publisher and an advertiser, and for receiving a digital file from the advertiser which includes advertisement information. For example, an advertiser logs onto the publisher's website, enters information about his advertisement, and the information is transmitted to the publisher via the communication link. The display is used for displaying to the advertiser a digital advertisement specification or an advertisement creation worksheet, and a set of related marketing information on how to most effectively use the advertisement that is being created. The information processing device is used for creating and editing an advertisement based on the advertisement information. A standard magazine publication printer is used for printing the advertisement.

Table 1 outlines the basic principles of the invention.

TABLE 1
Basic principles of the invention

1. Open secure data connection between the publisher and an advertiser/
editorial source, show login screen, and authenticate advertiser/editorial
source.
2. If the advertiser wishes to submit his own advertisement, display a
digital advertisement specification to the advertiser.
3. If the advertiser wishes the publisher to create an advertisement for
him, display an advertisement creation worksheet for the advertiser.
4. Receive and store a first digital file containing advertisement
information.
5. If the advertiser is scheduled by the publisher to be featured in an
editorial, display a set of editorial questions to the advertiser.
6. Receive and store a second digital file containing editorial information.
7. In order for the publisher to create an online advertisement, display a
set of website-related questions to the advertiser.
8. Receive and store a third digital file containing website information.
9. Publisher creates, edits, revises, and publishes a print advertisement,
an online advertisement, and/or an editorial article in collaboration with
the advertiser/editorial source.
10. Display to the advertiser a set of related marketing information,
including information on upcoming networking events, projected
publication dates, wise marketing practices, and how to use the published
advertisement, editorial article, and online advertisement in an
integrated portfolio of marketing tools.
11. Logout and close data connection

An example will improve understanding of the present invention; however this example by no means limits the scope of the present invention, but merely illustrates its spirit. The example used herein is described in conjunction with a magazine whose target audience is sophisticated brides. Manhattan Bride Magazine publishes advertisements and editorials about beauty salons. Manhattan Bride sends to the beauty salon (the advertiser) a digital advertisement specification (requirements) such as file format, resolution, color space, etc. which the beauty salon must conform to if they wish to supply the advertisement to the publisher. If the beauty salon wants the publisher to create an advertisement for them, the publisher sends advertisement questions, in the form of an advertisement creation worksheet, to the advertiser, which the advertiser must answer and submit to the publisher as advertisement information. Manhattan Bride then collects the advertisement information from the beauty salon, which includes its name, address, and other contact information, size of the advertisement image, color space, layout, title, mood, a description, etc. Manhattan Bride also collects editorial information from an editorial source (such as the advertiser himself, or a past customer of the beauty salon), which includes answers to editorial questions such as: “How can the bride start thinking about her hairstyle for her wedding?”; “What choices should she consider, in terms of her own look?”; and “What choices should she consider, in terms of her bridal fashions and wedding location?”

After all this information has been collected, Manhattan Bride creates an advertisement, and if it has collected editorial information, an editorial feature, covering the merchandise and services of the advertiser (i.e., the beauty salon). The online communication system facilitates this process by ensuring the publisher has all the necessary information to complete his task timely and accurately. Optionally, the publisher may also create an online-version of the advertisement and/or editorial feature on the publisher's website, using information specifically collected for that purpose.

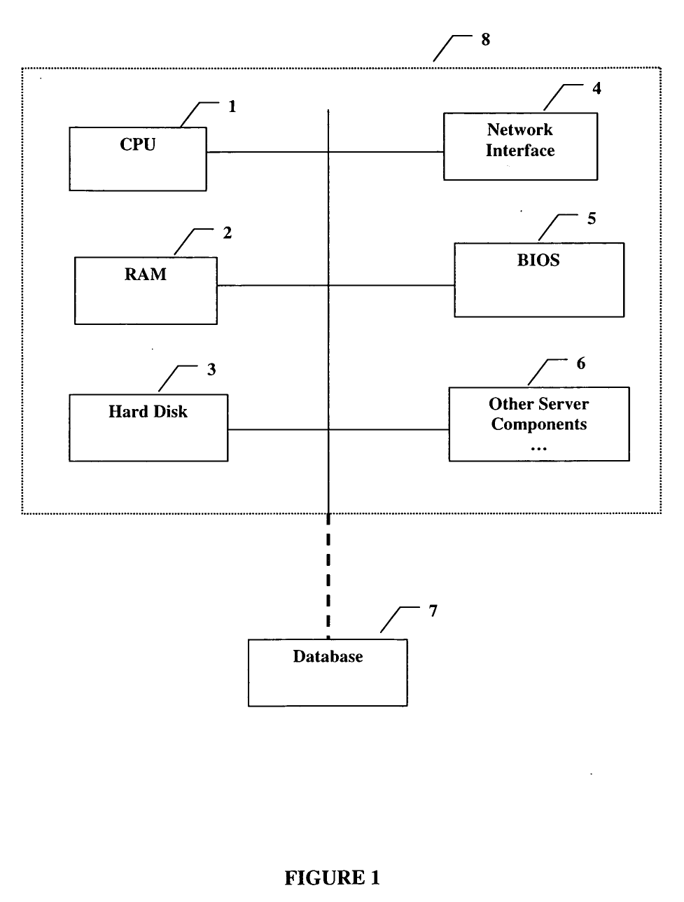

Turning now to the figures, in which like reference numerals refer to like elements, FIG. 1 shows the typical configuration of an information processing device in accordance with one embodiment of the present invention. As one example, the information processing device 8 comprises a computer in a server configuration, including a Central Processing Unit (CPU 1), Random Access Memory (RAM 2), a Hard Disk Drive 3, a Network Interface 4 (Ethernet), Basic Input/Output System (BIOS 5), and any other computer components 6 as deemed necessary by one of ordinary skill in the art to practice the invention. The information processing device 8 is connected to a Database 7 (Structured Query Language [SQL] Server, or the like), as is well known in the art. The database may reside on the information processing device, or be connected via the Network Interface 4 to another server which stores the database, as is well known by one skilled in the art of computer systems. The CPU 1, RAM 2, Hard Disk 3, Network Interface 4, BIOS 5, and Database 7 are all standard computer components that are well known and understood by one of ordinary skill in the art. Accordingly, those system components whose implementations are well understood in the art are not described in detail here.

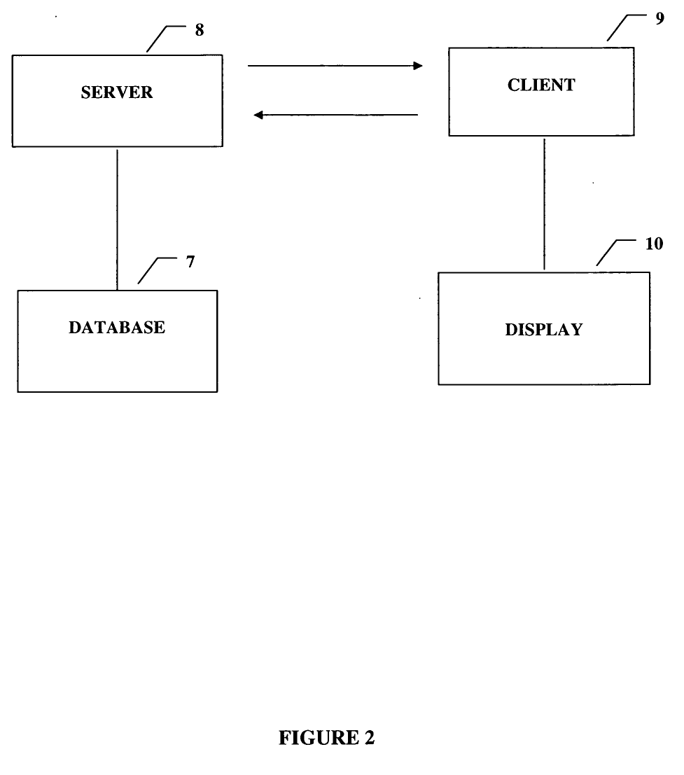

Turning now to FIG. 2, which depicts the overall system architecture according to one embodiment of the invention, a practical implementation of the system includes a Server 8 connected to a Database 7, and a Client 9 connected to a Display 10. The Server components have already been described with reference to FIG. 1. As noted previously in connection with FIG. 1, the database may reside on the Server 8, or may be connected via The Network Interface 4 to another server which stores the database. As noted previously, the system components are well known and understood in the art, and are not described in detail here.

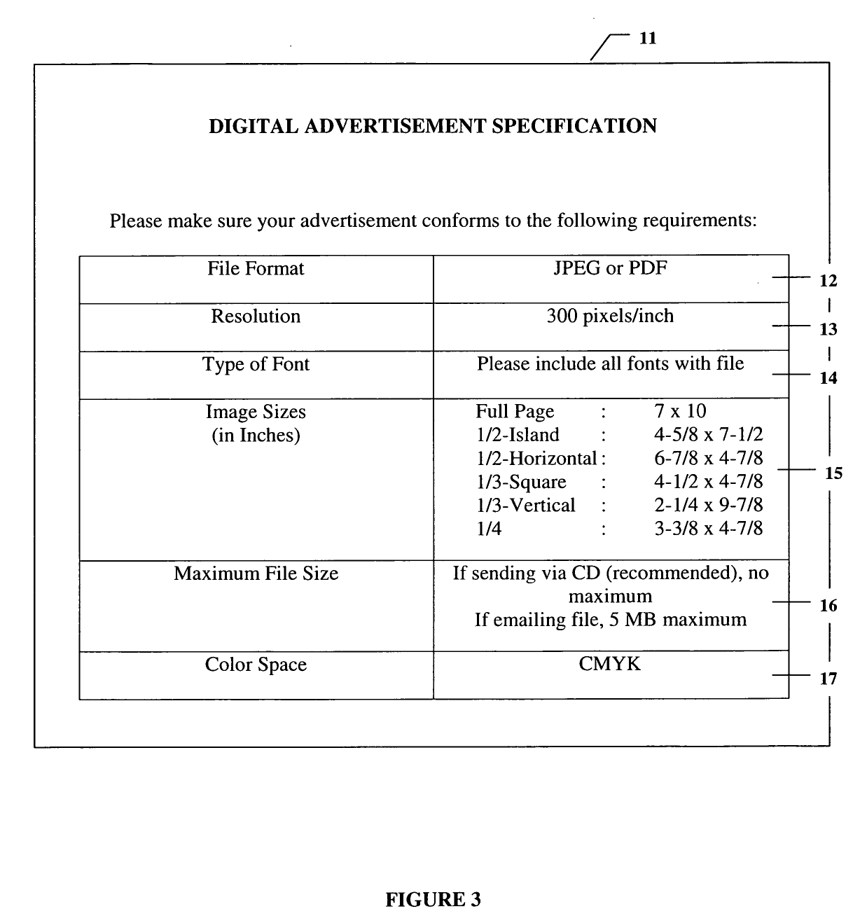

Turning now to FIG. 3, there is illustrated the digital advertisement specification 11 displayed by the publisher on the advertiser's information display device. In one embodiment, the digital advertisement specification 11 includes a file format 12, a display resolution 13, a type of font 14, an image size 15, a maximum file length 16, and a color space 17. The digital advertisement specification is by no means limited to this list, as will be well appreciated by one of ordinary skill in the art. After reviewing the digital advertisement specification on his display device, the advertiser may submit an advertisement image to the publisher which complies with all of the requirements listed in the digital advertisement specification.

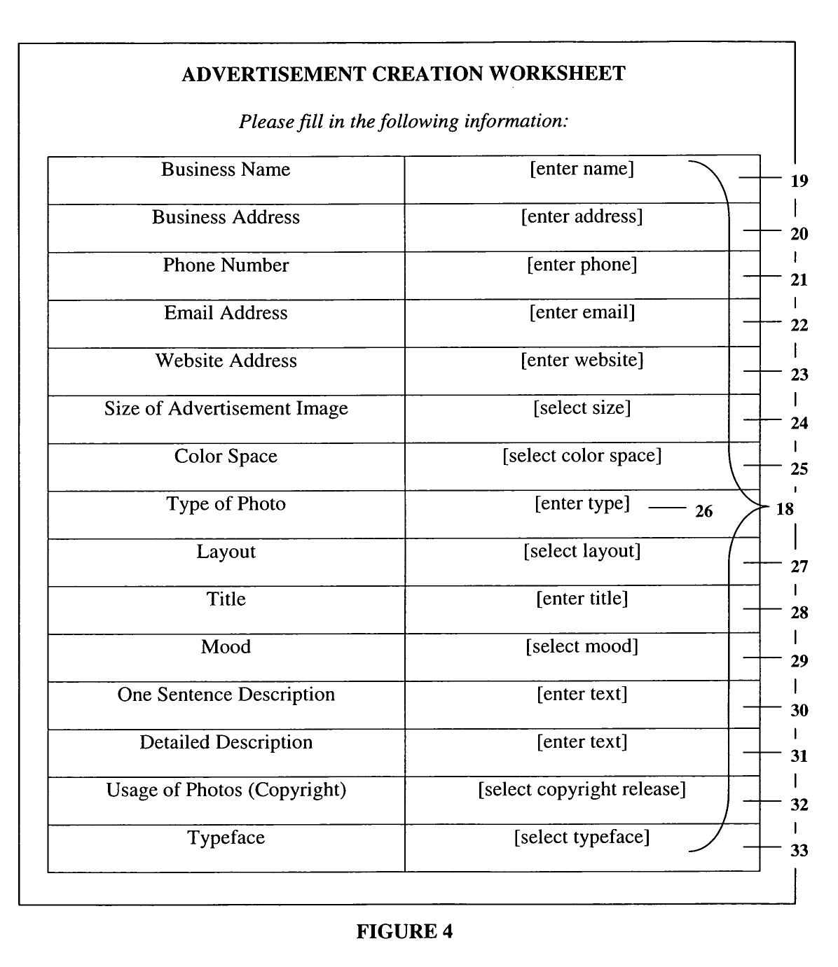

On the other hand, if the advertise wishes the publisher to create an advertisement for him, the advertiser submits the advertisement information illustrated in FIG. 4. The advertiser also keeps in mind the digital advertisement specification when submitting the advertisement information 18, thereby minimizing possibly incorrect, inaccurate, and duplicate submissions. In one embodiment, the advertisement information submitted by the advertiser to the publisher includes business name 19, business address 20, telephone number 21, email address 22, website address 23, size of the advertisement image 24, color space 25, type of photo 26, layout 27, title 28, mood 29, one sentence description 30, detailed description 31, usage of photos 32, and typeface 33. The advertisement information submitted to the publisher is by no means limited to this list, as will be well appreciated by one of ordinary skill in the art. For example, in the situation where the advertiser is a beauty salon looking to publish an advertisement in Manhattan Bride's Magazine, the advertisement information submitted by the beauty salon to Manhattan Bride would include “Jay's Beauty Salon” for business name, “121 5^{th} Avenue, NY, N.Y. 10150” for business address, “212 555-1213” for phone number, “jay@jaysalon.com” for email address, “www jaysalon.com” for website address, “4 in. by 6 in.” for size of advertisement image, “CMYK” for color-space, “photo of hairstyle” for type of photo, “vertical” for layout, “Visit Jay's Beauty Salon and receive a 15% discount!” for title, “sharp and sophisticated” for mood, “Jay's Beauty Salon will customize your hairstyle to your wedding dress!” for one sentence description, “We release all copyright information” for usage of photos (copyright), and “Helvetica 20 pt.” for typeface.

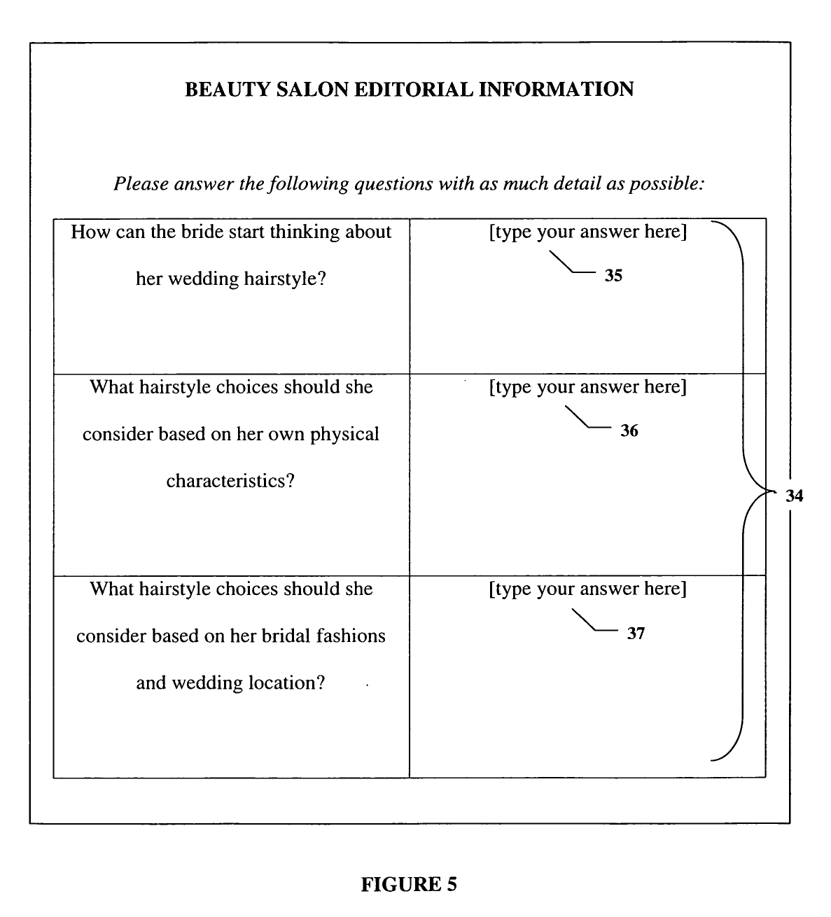

After the advertisement information has been collected, the publisher requests editorial information from the editorial source. As stated earlier, the advertiser and the editorial source may be the same person or the same company, or they may be different people or different companies. FIG. 5 depicts an example of an information collection screen which the publisher may use to gather editorial information 34 from the editorial source. FIG. 5 depicts the case where the editorial source is the advertiser (i.e., the beauty salon). The beauty salon is requested to submit editorial information 34, which may include answers to questions such as: “How can the bride start thinking about her wedding hairstyle?”; “What hairstyle choices should she consider based on her own physical characteristics?”; and “What hairstyle choices should she consider based on her bridal fashions and wedding location?” The editorial information depicted in FIG. 5 is only an illustrative embodiment of the inventive concept, and the editorial information is by no means limited to the specific answers to the specific types of questions show in FIG. 5. Editorial information is similarly not limited simply to answers to questions that the publisher provides. Editorial information may also include other information about a business that the editorial source thinks is relevant and important for inclusion by the publisher in an editorial about the business.

In one embodiment, the editorial information includes business name, business address, telephone number, email address, website address, and detailed editorial information, as described above. The editorial information submitted to the publisher is by no means limited to this list. As stated earlier, the submitted information may include advertisement information, or editorial information, or both.

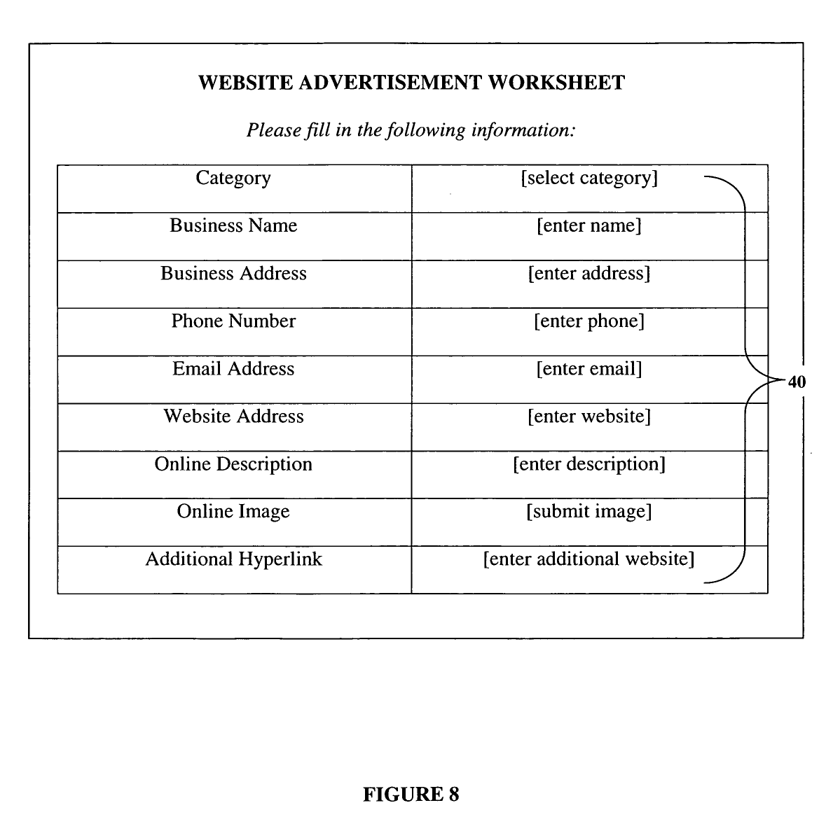

In another embodiment, the publisher collects information helpful to make an online version of the advertisement for publication on the publisher's website (see FIG. 8). The website information 40 may include, but is not limited to, a category, business name, business address, telephone number, email address, website address, an online description, an online image, and an additional hyperlink.

After the advertisement and editorial information have been collected as shown in FIG. 4 and FIG. 5, the publisher uses the gathered information to create an advertisement and/or an editorial feature and/or an online advertisement in collaboration with the advertiser and/or editorial source. After the advertisement and/or editorial feature and/or online advertisement has been created, edited, reviewed, and approved by the advertiser and/or editorial source, as is well known in the art of publishing, the advertisement and/or editorial feature is published in a subsequent magazine issue and/or published on the publisher's website.

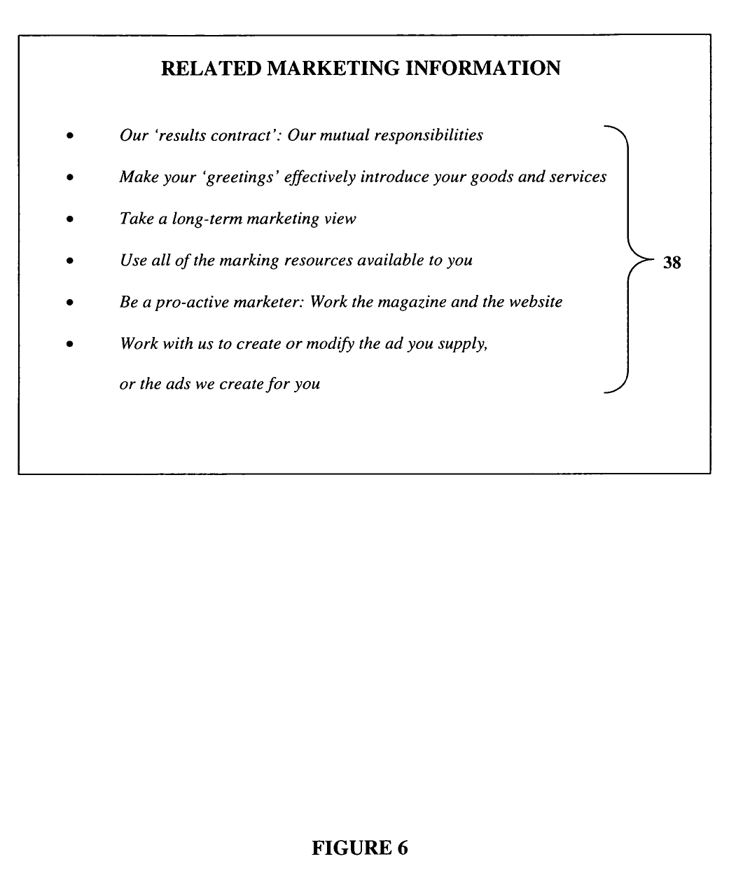

As shown in FIG. 6 and according to the inventive concept, the publisher displays to the advertiser a set of related marketing information to be used both in the process of submitting the advertisement information and/or editorial information, as well as subsequent to the publication of the advertisement. The set of related marketing information may include, but is not limited to, how to most effectively use the created advertisement in an integrated portfolio of marketing tools.

For example, in one particular embodiment, the set of related marketing information may include, but is not limited to, descriptions and explanations of important marketing practices. For example, the publisher displays to the advertiser the importance of making his ‘greetings’ effectively introduce his goods and services. The publisher instructs the advertiser the importance of taking a long-term marketing view, using all of the marketing resources available to him, and being a pro-active marketer by maximally utilizing (“working”) the magazine and the website. This marketing information is presented to the advertiser on the information display device. The publisher will also remind the advertiser to work with the publisher to create or modify the advertisement that the advertiser supplies or the advertisement that the publisher creates.

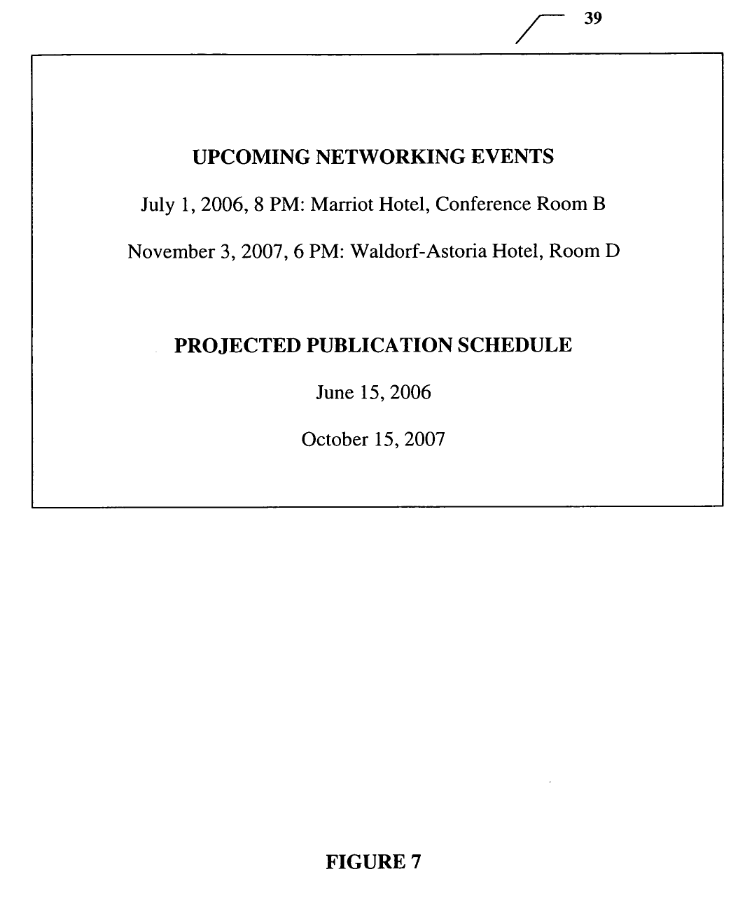

As shown in FIG. 7, in another related embodiment, the publisher may also provide information to the advertiser about networking events and/or publication schedule information indicating projected publication dates of the print magazine and/or online magazine. The networking events can include, but are not limited to, receptions where advertisers, customers, and the publisher interact and exchange business and contact information. According to a feature of the invention, the publisher communicates the importance of such networking events and other related marketing tools to the advertiser, and how to utilize the related marketing information in conjunction with the printed and online advertisement to turn the advertisement investment into the maximum revenue. This information, which includes instructional materials, is sent to the advertiser via the communication link and displayed on the information display device.

### Second Embodiment

A second embodiment of the invention is a method of collecting advertisement information from an advertiser and editorial information from an editorial source for use by a publisher in creating an advertisement. The method includes the steps of: (1) displaying to the advertiser a digital advertisement specification or an advertisement creation worksheet; (2) receiving and collecting a digital file from the advertiser and the editorial source, which includes advertisement information and editorial information; (3) displaying to the advertiser a set of related marketing information to be considered in preparing and submitting the advertisement information and the editorial information as well as subsequent to publication to most effectively use the advertisement (which was created from the advertisement information and the editorial information in the digital file).

According to yet another aspect of the inventive concept, the publisher receives payment information from the advertiser via the Internet, and processes the payment information to result in a payment from the advertiser to the publisher for the services rendered.

As will be readily seen by one of ordinary skill in the art, this embodiment of the invention may be practiced in an analogous fashion to the first embodiment, which has been described in detail above.

### Third Embodiment

In the situation where the advertisers are beauty salons, the editorial information shown in FIG. 5 preferably includes information about wedding hairstyles, the hairstyle choices the bride should consider based on her own physical characteristics, and the hairstyle choices she should consider based on her bridal fashions and wedding location.

### Fourth Embodiment

In the situation where the advertisers are bridal gown salons, gown designers, and others who might be featured in various exclusive photographic fashion shootings, including bridesmaid designers, children's fashion designers, fashion accessory designers, jewelers, shoe designers and retailers, and tuxedo designers and retailers, the editorial information shown in FIG. 5 provided to the editorial source preferably includes dates for the publisher to take photo shoots of merchandise samples, shooting locations, items requested for the shooting, location where the items should be delivered, return dates, and policies regarding potential damage. The editorial information also may include an indication of the number of items to be photographed by the publisher that were sent, a description of each item, a value of each, the name of the designer of each item, and any special credits to be provided.

### Fifth Embodiment

In the situation where the advertisers are cake designers, the editorial information shown in FIG. 5 preferably includes information relating to their cake creations, information on the inspiration behind their creations, the ingredients with which they prefer working, and the emotional response their cakes are designed to evoke.

### Sixth Embodiment

In the situation where the advertisers are calligraphers, the editorial information shown in FIG. 5 preferably includes information related to the uniqueness of their calligraphy the inspiration behind their line, what best characterizes their creations, and the emotional response they seek to evoke from their design.

### Seventh Embodiment

In the situation where the advertisers are caterers and others who might be featured in a “Perfect Wedding” section of Manhattan Bride magazine, including reception sites, restaurants, limousine companies, wedding planners, and others, the editorial information shown in FIG. 5 preferably include information on how the bride and groom can personalize their wedding with unique ideas, themes, colors, menus, decor, music, etc. that could express their personalities, their relationship, and their family traditions; information on some of the common (and not so common) problems that can happen; and information on “troubleshooting advice” to avoid these problems. This information would give insight to the sophisticated bride into how to create a more prefect wedding in terms of the advertiser's and/or editorial source's special expertise (in say, flowers, music, venues, wedding planning, etc.). It would also convey to the sophisticated bride how the advertiser's merchandise or services would fit into the bride's “perfect wedding.”

### Eighth Embodiment

In the situation where the advertisers are cosmetic dentists, the editorial information shown in FIG. 5 preferably includes information on when and why someone should consider various dental services offered, the beauty and health benefits that can be achieved, information on the different services offered and any specialty services, how the cosmetic dentist got into the field and what he enjoys about it, and any suggestions he may have for general dental health. The editorial information sent from the dentist to the publisher may also include types of questions asked by the cosmetic dentist of someone interested in the various procedures.

### Ninth Embodiment

In the situation where the advertisers are those offering ceremonial objects and others who might be featured in the “Something Old, Something New” section of Manhattan Bride Magazine, including venues, planners, those offering guest accommodations, dance instructors, and others, the editorial information shown in FIG. 5 preferably includes information on the unique benefits provided by the products or services offered, what is “new” about each (updated styling, new technology, more/better features, etc.), what is “old” about each (historical inspiration, traditional styling or values, etc.), how they got involved in the field, and the most exciting aspect of it. This information is provided by answering questions from the publisher, such as of the type shown in FIG. 5.

### Tenth Embodiment

In the situation where the advertisers are those offering children's fashions, the editorial information shown in FIG. 5 preferably includes information on what makes their creations unique, the inspiration behind the line of fashion, what best design characterizes the collection, and the emotional response intended to be evoked by the fashion design.

### 11th Embodiment

In the situation where the advertisers are those offering crystal, china, and other registry items, the editorial information shown in FIG. 5 preferably includes information on the key questions about personal style that a bride must ask herself and her groom before planning her registry; how that personal style translates into particular choices for dinnerware, flatware, crystal, etc.; how the bride can combine new items for her registry with old items that might be passed down from family members, and what other “mix and match” aspects (accent dishes, accent items, and other combinations) she might consider; how she can plan her registry for both formal and casual meals and entertaining; how she can plan her registry for the meals and entertaining she will be doing now, but in such a way that her registry can grow with her as she and her husband expand their concept of entertaining. The editorial information also includes special services and products provided by the advertiser; the complete process the bride goes through when registering with the advertiser; and information on holiday entertaining, entertaining indoors and out, intimate dinner parties, dressing a table, entertaining at home, table settings for various personalities, and entertaining together.

### 12th Embodiment

In the situation where the advertisers are those offering favors or gifts or invitations, the editorial information shown in FIG. 5 preferably includes information related to their favors or gifts or invitations, what is the inspiration behind their line of gifts, what best characterizes their creations, and the emotional response intended to be evoked by their designs.

### 13th Embodiment

In the situation where the advertisers are floral designers, the editorial information shown in FIG. 5 preferably includes information related to each bouquet to be photographed, the flowers and other elements used to create each bouquet, how the bride's preferences and the flowers themselves inspired each bouquet, and how these bouquets are characteristic of the creations of the advertiser.

### 14th Embodiment

In the situation where the advertisers are those offering fitness services, the editorial information shown in FIG. 5 preferably includes information on the fitness philosophy of the fitness center; what it considers in creating a fitness routine, such as current fitness level, body type, fitness goals, personal preferences, etc., and how that determines what the fitness center does; the elements of the workout program created, the benefits of each, and how it can be modified for each person or couple; how bridal couples can exercise together, at home, in the gym, and outdoors; what concerns are communicated by the fitness center to the bride about the bride's overall goals, risks of certain exercises, diet, etc., and how can they be dealt with; how the fitness center got into the field; and what is most satisfying about working with brides.

### 15th Embodiment

In the situation where the advertisers are musical performers and entertainers, the editorial information shown in FIG. 5 preferably includes information on the most important questions a bride should ask about her wedding music; the most interesting recent wedding at which the advertiser performed; how the bride and groom can plan the music for the cocktail hour, ceremony, and reception; what the editorial source offers that is unique in terms of staff, experience, range, or history; how the editorial source got into the business, when the band was founded and what types of music they play; and what is most exciting about playing a wedding.

### 16th Embodiment

In the situation where the advertisers are officiants, the editorial information shown in FIG. 5 preferably includes information on how the bride and groom can personalize their ceremony; information on unique ideas, themes, and vows that can express their personalities, their relationship, and their family traditions; common (and not so common) problems that can happen in the ceremony; troubleshooting advice that can avoid these problems; how the editorial source became an officiant; and the most satisfying thing about what he does.

### 17th Embodiment

In the situation where the advertisers are photographers and videographers, the editorial information shown in FIG. 5 preferably includes information relating to particular images, what is special about several of the particular photos the editorial source has chosen, in terms of the mood or action of the moment, the people, and/or what led up to the scene.

### 18th Embodiment

In the situation where the advertisers are restaurants, as may be featured in the rehearsal dinner portion of the wedding celebration, the editorial information shown in FIG. 5 preferably includes information relating to the events of a typical rehearsal dinner; how to make a rehearsal dinner unique; dishes, decor, traditional customs, or elements which could make it unique; the unique offerings of the editorial source, in terms of menus, ambiance, floral decor, music, etc.; if they offer bachelor or bachelorette parties; and how they would structure a rehearsal dinner in relation to the wedding itself.

### 19th Embodiment

In the situation where the advertisers are reception sites, restaurants, and hotels which might be featured in the “Real Wedding” section of Manhattan Bride Magazine, featuring articles about real weddings, the editorial information shown in FIG. 5 preferably includes information on a particular wedding, specifically the ceremony and reception location, ring designer, gown designer, headpiece and tiara designer, bridesmaid designer, makeup and hair artist, tuxedo designer, florist, cake designer, photographer, videographer, entertainment, and honeymoon location. The editorial information also may include information describing the specific bridal couple: how they met, the proposal, working with their venue, and their wedding day. The editorial information also may be directed to the venue and the bridal couple about the photos to supply, including the number of photos to send, the categories of photos to include: the bride and groom, candid fun shots, bridal portrait, the bridal party, personality shots, and the venue and decor; and mailing information for the bride including her name, street address, city, state, phone, and e-mail. This information is supplied by the advertiser in response to questions displayed on, for example, display 10 of FIG. 2.

### 20th Embodiment

In the situation where the advertisers are honeymoon resort locations, the editorial information shown in FIG. 5 preferably includes information relating to the resort's physical description (the number and description of guest rooms including the honeymoon suites; restaurants and cuisine offered; special facilities and sports, grounds, beaches, pools; and nearby points of interest to visit); the most romantic dishes, drinks, locations, views, moments, times of the day, activities, or other features of the resort; the resort's unique features and what honeymooners like best; if the resort accommodates destination weddings; and what options and services the resort offers. The editorial information also may relate to local customs, both those true to native roots and those that are more modern; what a typical local wedding includes in both the ceremony and the reception; and if there is a ceremonial dress code for the bride and the groom.

### 21st Embodiment

In the situation where the advertisers are venues (reception cites, banquet halls, hotels, and restaurants), the editorial information shown in FIG. 5 preferably includes answers to the following questions: (I) What are the key questions a bride & groom should ask in choosing their venue? (2) How can they be guided by their own personalities in making this decision? (3) What type of venue features and services should they be looking for if they are: formal or informal; spontaneous or highly planned; have a special theme or do not; and to include family and friends in a special way or not? (4) How can they also be guided by their own personalities in shaping their wedding itself? (5) What types of decorations work well for various settings and bridal personalities? What works well for your setting? (6) How can the couple incorporate—or create their own—various traditions to include in their wedding? (7) What special services or options do you offer your brides? (8) What is the history of your venue? And can you describe some of your most memorable recent weddings—in terms of decor, food, ambiance, themes, events, or any other element? and (9) How did you personally get into the business? And for you, what is the most exciting thing about throwing a wedding? The editorial source is encouraged to provide specific examples and detailed anecdotes in response to each of the above questions.

It will be appreciated from the above that the invention may be implemented as computer software, which may be supplied on a storage medium or via a transmission medium such as a network or the Internet.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What is claimed is:

1. A method of collecting information from an advertiser and an editorial source, comprising:
displaying to the advertiser a digital advertisement specification or an advertisement creation worksheet and a set of editorial questions;
receiving a first digital communication from the advertiser including advertisement information or advertisement image information; and
receiving a second digital communication from the editorial source including editorial information.

2. The method according to claim 1, wherein the digital advertisement specification includes one or more of a file format, a resolution, a type of font, an image size, a maximum file length, and a color space.

3. The method according to claim 1, wherein the advertisement information includes one or more of a business name, a street address, a city, a state, a zip code, a phone number, an email address, a website address, other contact information, a size of the advertisement image, a color space, a type of photo, a layout, a title, a mood, a one sentence description, a detailed description, a usage of photos, a layout description, a title description, and a typeface.

4. The method according to claim 1, wherein the editorial information includes one or more of a business name, a street address, a city, a state, a zip code, a phone number, an email address, and a website address.

5. The method according to claim 4, wherein the editorial information further includes answers to questions which relate to the advertiser specifically in terms of goods or services offered by the advertiser.

6. The method according to claim 4, wherein the editorial information further includes specific questions a bride must consider in properly evaluating the advertiser's goods or services.

7. The method according to claim 4, wherein the editorial information further includes answers to questions which relate to selecting or tailoring the advertiser's goods or services to best match a particular personality of a bride and/or a groom.

8. The method according to claim 4, wherein the editorial information further includes answers to questions related to how best to coordinate the advertiser's goods or services with other aspects of a bride's wedding.

9. The method according to claim 4, wherein the editorial information further includes information related to problems that can occur in using the advertiser's goods or services and how the problems can be overcome.

10. The method according to claim 4, wherein the editorial information further includes insights into the advertiser's background and approach to the advertiser's goods or services.

11. The method according to claim 1, further comprising:
displaying to the advertiser a set of related marketing information to be considered in preparing and submitting the advertisement information and the editorial information as well as subsequent to publication to most successfully utilize the advertisement.

12. The method according to claim 11, wherein the set of related marketing information includes one or more of instructions on how to make greetings effectively introduce the advertiser's good or services, how to take a long-term marketing view, how to use all of the marketing information available, how to be a pro-active marketer, and how to work with the publisher to create or modify the advertisement.

13. The method according to claim 1, further comprising:
sending event information about upcoming networking events to the advertiser.

14. A system for collecting information from an advertiser and an editorial source for use in creating an advertisement, the system comprising:
display means for displaying to an advertiser and an editorial source a digital advertisement specification or an advertisement creation worksheet and a set of editorial questions; and
communication means for receiving advertisement information and editorial information from the advertiser and the editorial source.

15. The system according to claim 14, wherein the digital advertisement specification includes one or more of a file format, a resolution, a type of font, an image size, a maximum file length, and a color space.

16. The system according to claim 14, wherein the advertisement information includes one or more of a business name, a street address, a city, a state, a zip code, a phone number, an email address, a website address, other contact information, a size of the advertisement image, a color space, a type of photo, a layout, a title, a mood, a one sentence description, a detailed description, a usage of photos, a layout description, a title description, and a typeface.

17. The system according to claim 14, wherein the editorial information includes one or more of a business name, a street address, a city, a state, a zip code, a phone number, an email address, and a website address.

18. The system according to claim 17, wherein the editorial information further includes answers to questions which relate to the advertiser specifically in terms of the goods or services offered by the advertiser.

19. The system according to claim 17, wherein the editorial information further includes specific questions a bride must consider in properly evaluating the advertiser's goods or services.

20. The system according to claim 17, wherein the editorial information further includes answers to questions which relate to selecting or tailoring the advertiser's goods or services to best match a particular personality of a bride and/or a groom.

21. The system according to claim 17, wherein the editorial information further includes answers to questions related to how best to coordinate the advertiser's goods or services with other aspects of a bride's wedding.

22. The system according to claim 17, wherein the editorial information further includes information related to problems that can occur in using the advertiser's goods or services and how the problems can be overcome.

23. The system according to claim 17, wherein the editorial information further includes insights into the advertiser's background and approach to the advertiser's goods or services.

24. The system according to claim 14, wherein the display means further displays to the advertiser a set of related marketing information to be considered in preparing and submitting the advertisement information and the editorial information as well as subsequent to publication to most successfully use the advertisement.

25. The system according to claim 24, wherein the set of related marketing information includes one or more of instructions on how to make greetings effectively introduce the advertiser's good or services, how to take a long-term marketing view, how to use all of the marketing information available, how to be a pro-active marketer, and how to work with the publisher to create or modify the advertisement.

26. A method of collecting information from an advertiser adapted for use by a publisher utilizing an information processing device, an information display device, and a communication link, the method comprising:
displaying to the advertiser on the information display device a digital advertisement specification or an advertisement creation worksheet communicated via the communication link;
receiving and storing at the information processing device a digital communication including advertisement information from the advertiser via the communication link; and
displaying to the advertiser on the information display device a set of related marketing information to be considered in preparing and submitting the advertisement information as well as subsequent to publication to most effectively use the advertisement, the marketing information being communicated to the advertiser via the communication link.

27. The method according to claim 26, wherein the digital communication is in a form suitable for publishing in print and/or online.

28. The method according to claim 26, further comprising:
sending event information about upcoming networking events to the advertiser from the information processing device via the communication link; and
communicating to the advertiser the importance of the networking events, and how to use the networking events in an integrated portfolio of marketing tools.

29. The method according to claim 26, further comprising:
receiving and storing at the information processing device website information from the advertiser for an online advertisement communicated via the communication link.

30. The method according to claim 29, wherein the website information includes one or more of a category, a business name, a street address, a city, a state, a zip code, a phone number, an email address, a website address, a contact name for listing, a contact name for updates, a brief description, a hyperlink, and an online image.

31. The method according to claim 26, further comprising:
receiving payment information from the advertiser via the communication link; and
processing the payment information to cause a payment from the advertiser to the publisher.

32. The method according to claim 26, further comprising:
displaying deadline information to the advertiser and/or editorial source, the deadline information indicating deadlines for submitting the advertisement information and the editorial information to the publisher.

33. The method according to claim 26, further comprising:
displaying schedule information to the advertiser, the schedule information indicating dates of publication.

34. The method according to claim 26, wherein the communication link is a wide-area network or the Internet.

35. The method according to claim 26, wherein the information display device is a web browser.

36. The method according to claim 26, wherein the digital advertisement specification includes one or more of a file format, a resolution, a type of font, an image size, a maximum file length, and a color space.

37. The method according to claim 26, wherein the advertisement information includes one or more of a business name, a street address, a city, a state, a zip code, a phone number, an email address, a website address, other contact information, a size of the advertisement image, a color space, a type of photo, a layout, a title, a mood, a one sentence description, a detailed description, a usage of photos, a layout description, a title description, and a typeface.

38. The method according to claim 26, wherein the set of related marketing information includes one or more of instructions on how to make greetings effectively introduce the advertiser's good or services, how to take a long-term marketing view, how to use all of the marketing information available, how to be a pro-active marketer, and how to work with the publisher to create or modify the advertisement.

39. A system for collecting information from an advertiser adapted for use by a publisher, the system comprising:
communication means for communicating between the advertiser and the publisher;
display means for displaying to the advertiser a digital advertisement specification or an advertisement creation worksheet and for displaying to the advertiser a set of related marketing information to be considered in preparing and submitting the advertisement information as well as subsequent to publication to most effectively use the advertisement, the digital advertisement specification, the advertisement creation worksheet, and the set of related marketing information being communicated to the advertiser via the communication means; and
storage means for storing a digital communication from the advertiser received via the communication means, the digital communication including advertisement information or advertisement image information.

40. The system according to claim 39, wherein the digital communication is in a form suitable for publishing in print and/or online.

41. The system according to claim 39, wherein the digital communication takes place over a wide-area network or the Internet.

42. The system according to claim 39, wherein the display means is a web browser.

43. The system according to claim 39, wherein the digital advertisement specification includes one or more of a file format, a resolution, a type of font, an image size, a maximum file length, and a color space.

44. The system according to claim 39, wherein the advertisement information includes one or more of a business name, a street address, a city, a state, a zip code, a phone number, an email address, a website address, other contact information, a size of the advertisement image, a color space, a type of photo, a layout, a title, a mood, a one sentence description, a detailed description, a usage of photos, a layout description, a title description, and a typeface.

45. The system according to claim 39, wherein the set of related marketing information includes one or more of instructions on how to make greetings effectively introduce the advertiser's good or services, how to take a long-term marketing view, how to use all of the marketing information available, how to be a pro-active marketer, and how to work with the publisher to create or modify the advertisement.

46. A method of collecting information from an advertiser, and editorial information from an editorial source, adapted for use by a publisher utilizing an information processing device, an information display device, and a communication link, the method comprising:
displaying to the advertiser on the information display device a digital advertisement specification or an advertisement creation worksheet and a set of editorial questions communicated via the communication link;
receiving and storing at the information processing device a digital communication from the advertiser and the editorial source via the communication link, the digital communication including advertisement information or advertisement image information and editorial information; and
displaying to the advertiser on the information display device a set of related marketing information to be considered in preparing and submitting the advertisement information and the editorial information as well as subsequent to publication to most effectively use the advertisement and/or editorial, the marketing information being communicated to the advertiser and editorial source via the communication link.

47. The method according to claim 46, further comprising:
sending event information to the advertiser from the information processing device via the communication link.

48. A method of creating an advertisement adapted for use by a publisher of a magazine, the method comprising:
displaying to an advertiser a digital advertisement specification or an advertisement creation worksheet and a set of related marketing information;
receiving and storing a digital communication including advertisement information from the advertiser;
creating and editing the advertisement based on the received advertisement information;
sending the advertisement to the advertiser for review;
revising the advertisement based on the advertiser's review; and
publishing the advertisement,
wherein the set of related marketing information is to be considered in preparing and submitting the advertisement information as well as subsequent to publication to most effectively use the advertisement in an integrated portfolio of marketing tools.

49. A system for creating an advertisement for use by a publisher of a magazine, the system comprising:
a communication link for communicating between the publisher and an advertiser, and for receiving a digital communication, including advertisement information, from the advertiser;
a display for displaying to the advertiser a digital advertisement specification or an advertisement creation worksheet, and a set of related marketing information;
an information processing device for creating and editing an advertisement based on the advertisement information; and
a printer for printing the advertisement,
wherein the set of related marketing information is to be considered in preparing and submitting the advertisement information as well as subsequent to publication to most effectively use the advertisement in an integrated portfolio of marketing tools.

50. A method of collecting information from an advertiser and editorial information from an editorial source adapted for use by a publisher utilizing an information processing device, an information display device, and a communication link, the method comprising:
displaying to the advertiser on the information display device a digital advertisement specification or an advertisement creation worksheet and a set of editorial questions communicated via the communication link;
receiving and storing at the information processing device a first digital communication from the advertiser via the communication link, the first digital communication including advertisement information or advertisement image information;
receiving and storing at the information processing device a second digital communication from the editorial source via the communication link, the second digital communication including editorial information;
receiving and storing at the information processing device a third digital communication from the advertiser via the communication link, the third digital communication including website information expressly tailored to be published online; and
displaying to the advertiser on the information display device a set of related marketing information communicated to the advertiser via the communication link, the set of related marketing information is to be considered in preparing and submitting the advertisement information and the editorial information as well as subsequent to publication to most effectively use the advertisement and/or editorial in an integrated portfolio of marketing tools.

51. The method according to claim 50, further comprising:
sending event information about upcoming networking events to the advertiser from the information processing device via the communication link.

52. A system for collecting advertising information from an advertiser and editorial information from an editorial source adapted for use by a publisher, the system comprising:
communication means for communicating between the publisher and the advertiser and editorial source;
display means for displaying to the advertiser a digital advertisement specification or an advertisement creation worksheet, a set of editorial questions, and a set of related marketing information communicated via the communication means;
first storage means for receiving and storing a first digital communication from the advertiser via the communication means, the first digital communication including advertisement information or advertisement image information;
second storage means for receiving and storing a second digital communication from the editorial source via the communication means, the second digital communication including editorial information; and
third storage means for receiving and storing a third digital communication from the advertiser via the communication means, the third digital communication including website information expressly tailored to be published online,
wherein the set of related marketing information is to be considered in preparing and submitting the advertisement information and the editorial information as well as subsequent to publication to most effectively use the advertisement and/or editorial in an integrated portfolio of marketing tools.

53. The system according to claim 52, wherein the communication means further sends event information about upcoming networking events to the advertiser.
